(19) United States
(12) Patent Application Publication
(10) Pub. No.: US 2025/0168887 A1
(43) Pub. Date: May 22, 2025

(54) ADAPTIVE CODE ASSIGNMENT TO AMBIENT POWER STATIONS

(71) Applicant: Cisco Technology, Inc., San Jose, CA (US)

(72) Inventors: Ugo M. CAMPIGLIO, Morges (CH); Domenico FICARA, Essertines-Sur-Yverdon (CH); Leo CALDAROLA, Morrens (CH)

(21) Appl. No.: 18/511,336

(22) Filed: Nov. 16, 2023

(51) Int. Cl. H04W 74/08; H04W 84/12

(52) U.S. Cl. CPC H04W 74/0833; H04W 74/0816; H04W 84/12

(57) ABSTRACT

Embodiments herein describe using transmission codes for ambient power stations (AMP STAs) so multiple AMP STAs can transmit in parallel to a Wi-Fi access point (AP). In order for the AMP STAs to transmit in parallel, the STAs use different codes. In one embodiment, the AMP STAs can use random timers to determine when they transmit and select a code to use during transmission. Before the timer expires, the AMP STAs can listen to see whether other AMP STAs are using the same code (e.g., a collision), and if so, select a different code. However, some AMP STAs may not have the ability to detect a collision. In that case, the AP can determine collisions for the AMP STAs and instruct the AMP STAs to select different codes.

### TECHNICAL FIELD

Embodiments presented in this disclosure generally relate to providing secure wireless communications in a network. More specifically, embodiments disclosed herein provide for onboarding backscatter devices onto a local network for secure communication.

### BACKGROUND

At the IEEE 802.11 working group, the AMP (AMbient Power) study group is considering the integration of backscattering devices (BKDs) into Wi-Fi networks. Generally, a system transmits energy that BKDs receive and use for their own transmissions. In one form, the BKD is entirely passive, and merely reflects (thus in real time) the energy. In another form, the BKD can accumulate the energy in an energy storage component, such as a capacitor, until reaching a threshold at which transmission becomes possible (thus transmission is not concurrent to the received Wi-Fi signal, but can still happen at any time after enough energy has accumulated).

In either mode, the BKD transmission can interfere with neighboring Wi-Fi devices transmissions. This is even more challenging because the BKD may transmit at any time the energy storage device has enough energy to transmit and may not wait for instructions from an AP to transmit. Current solutions ignore this problem, as they focus on the BKD as the primary subject. As such, current solutions do not provide guidance for permitting BKDs to function in a Wi-Fi environment with minimal contention.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 is a communication system where AMP stations select codes for transmission, according to one embodiment.

FIG. 2 is a flowchart for selecting codes for AMP stations, according to one embodiment.

FIG. 3 is a timing chart for selecting codes for AMP stations, according to one embodiment.

FIG. 4 is a flowchart for selecting codes for AMP stations, according to one embodiment.

FIG. 5 is a timing chart for selecting codes for AMP stations, according to one embodiment.

FIG. 6 is a flowchart for selecting codes for AMP stations, according to one embodiment.

FIG. 7 depicts an example computing device configured to perform various aspects of the present disclosure, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment described herein is a method that includes initiating, at a first ambient power station (AMP STA), a random timer upon receiving an illumination signal from an access point (AP), selecting, at the first AMP STA and after receiving the illumination signal, a first code to use for backscatter communications transmitted to the AP, and upon determining a second AMP STA is using the first code for backscatter communications, selecting, at the first AMP STA, a second code to use for backscatter communications to the AP.

Another embodiment described herein is an AMP STA that includes a random timer configured to initiate when the AMP STA receives an illumination signal from an AP and a code selector configured to select, after receiving the illumination signal, a first code to use for backscatter communications transmitted to the AP that is not used by any other AMP STA currently transmitting backscatter signals to the AP.

Another embodiment described herein is an AP that includes one or more processors and memory configured to execute an application which, when executed by the one or more processors, performs an operation. The operation includes transmitting an illumination signal to a first AMP STA and a second AMP STA where the first AMP STA and the second AMP STA (i) initiate respective random timers and (ii) select orthogonal codes to use when transmitting backscatter communications to the AP, detecting a collision when receiving backscatter communications from both the first AMP STA and the second AMP STA use the same orthogonal code, and transmitting, in response to detecting the collision, a retry message to the first AMP STA and the second AMP STA where the first AMP STA and a second AMP STA (i) reset the respective random timers and (ii) select new orthogonal codes to use when transmitting backscatter communications to the AP.

### Example Embodiments

Embodiments herein describe using transmission codes for AMP stations (STAs) so multiple AMP STAs can transmit in parallel to a Wi-Fi access point (AP). AMP STAs can include BKD devices (or BKD STAs) that can store energy (e.g., in capacitors) from received RF energy and BKD devices that are purely passive and reflect RF energy without storing it.

In order for the AMP STAs to transmit in parallel, the STAs should use different codes, such as Code-Division Multiple Access (CDMA) codes. CDMA codes use a Direct Sequence Spread Spectrum (DSSS) property where the transmitter and the receiver use the same spreading code to transmit data. In one embodiment, the AMP STAs can use random timers to determine when they transmit and randomly select a code to use during transmission. Before the timer expires, the AMP STAs can listen to see whether other AMP STAs are using the same code (e.g., a collision), and if so, select a different code.

However, some AMP STAs may not have the ability to detect when a collision (or a potential collision) occurs. In that embodiment, the AP can determine collisions for the AMP STAs. If the AP detects that two (or more) AMP STAs are using the same transmission code, the AP can transmit a reset signal that instructs the AMP STAs to reset their random timers and select a new code. Once the AMP STAs have selected different codes, they can transmit in parallel to the AP using the codes.

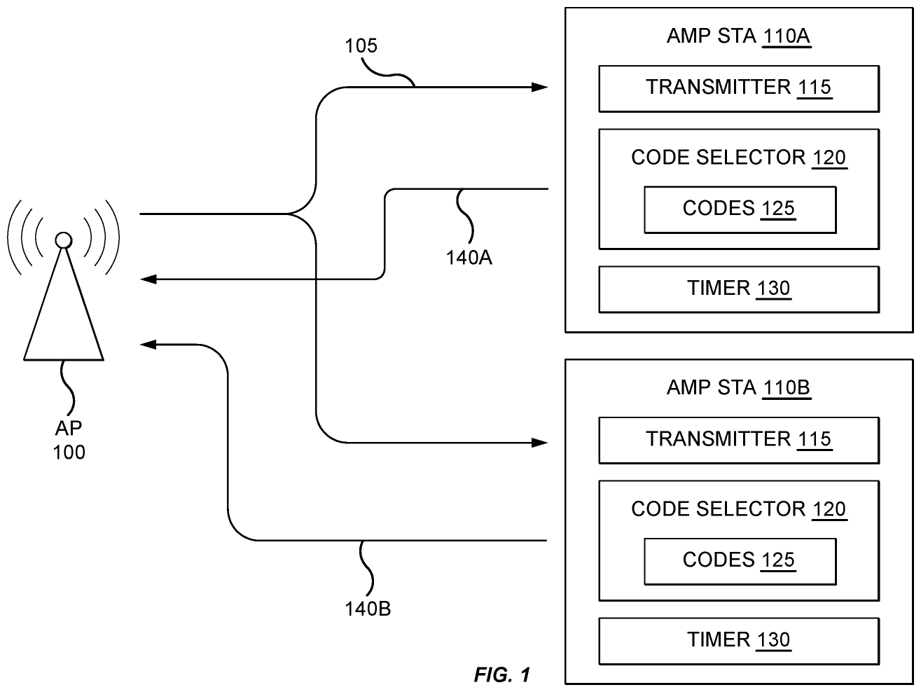

FIG. 1 is a communication system where AMP STAs select codes for transmission, according to one embodiment. In one embodiment, the AMP STA 110 is a passive device that relies on received wireless transmissions 105 from the AP 100 to provide it with power to transmit a reply 140. For example, the AMP STA 110 may not have a battery or be connected to a power source (e.g., plugged into an outlet). Instead, the power of a received wireless signal can be used to power a transmitter 115 in the AMP STA 110 so it can transmit wireless signals.

In another embodiment, the AMP STA 110 includes a power storage element (e.g., one or more capacitors) that permit it to store energy received from the transmission 105. In this scenario, the AMP STA 110 could transmit the reply 140 after the wireless transmission 105 has stopped. For example, the AMP STA 110 could receive the transmission 105, store its energy in its power storage element, and then later decide (e.g., after it has data ready to send to the AP 100) to transmit the reply 140.

In one embodiment, the AMP STA 110 is a radio frequency identification (RFID) tag, an environmental sensor, a tracking device, and the like. The AMP STA 110 may be a mobile device or a stationary device. For example, the AMP STA 110 may be attached to an item that moves around a physical environment (e.g., a cart). In another example, the AMP STA 110 may be stationary (e.g., a temperature or humidity sensor mounted onto a wall or roof).

In this example, the AP 100 transmits the wireless transmission 105 to the AMP STA 110. This wireless transmission 105 can provide power to the transmitter 115 in the AMP STA 110 so it can wireless transmit the reply 140. The wireless transmission 105 can have the same frequency as the reply 140, or the two transmissions may be at different frequencies.

In addition to having the transmitters 115, each of the AMP STAs 110 include a code selector 120 and a timer 130. The code selector 120 can include circuitry that includes a memory that stores codes 125 used for transmitting data to the AP 100 using the replies 140. In one example, the codes 125 are CDMA codes. CDMA is a form of multiplexing, which allows numerous signals to occupy a single transmission channel, optimizing the use of available bandwidth. While CDMA codes are one example, the embodiments are not limited to such. Any type of orthogonal code could be used so long as the codes permit the AMP STAs 110 to transmit replies 140 in the same frequency range in parallel (e.g., the same transmission channel or channels).

Because there may be a limited number of the codes 125, it may be impossible to assign every AMP STA 110 that is manufactured a unique code. Instead, the code selector 120 can store a number of codes 125 that have already been calculated and stored in the AMP STA 110. One of the codes 125 is chosen by the AMP STA 110 using the embodiments described below. Because the codes 125 stored in the AMP STA 110A may be the same set of codes as (or at least partially overlaps with) the codes 125 stored in the AMP STA 110B, they may select the same code to use. The embodiments discussed below describe various techniques that can be used to mitigate collision (i.e., when two or more AMP STAs select the same code 125), and to recover from collisions when they do occur.

The AMP STAs 110 also include a timer 130. The timer 130 can be a random timer that is used to indicate when an AMP STA 110 begins to transmit. In one embodiment, the random timer 130 can be used to select which code 125 to use when transmitting the replies 140. In another embodiment, a different random value may be used to select the code 125.

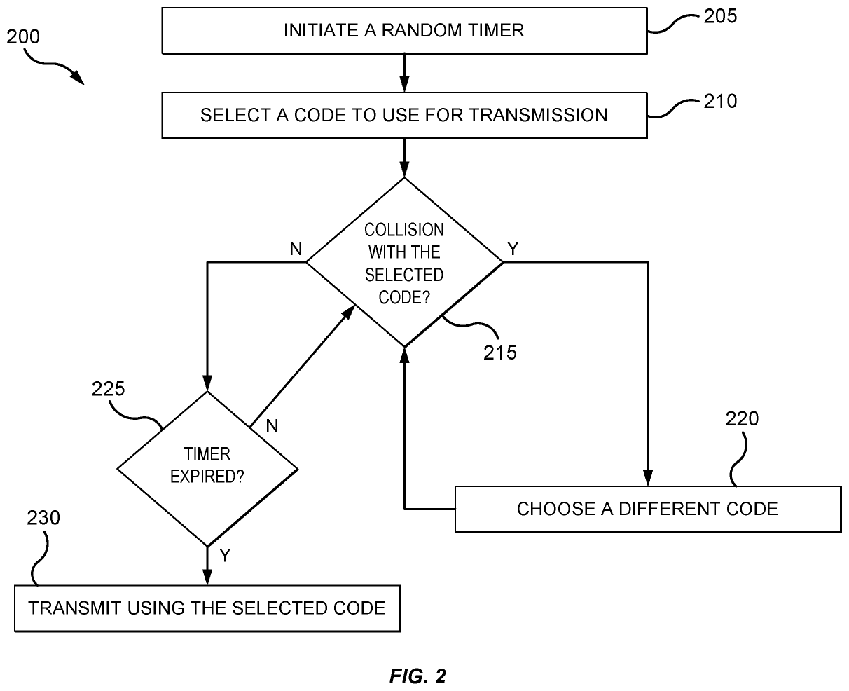

FIG. 2 is a flowchart of a method 200 for selecting codes for AMP STAS, according to one embodiment. In one embodiment, the method 200 may occur while the AP transmits a wireless illumination signal to the AMP STA. The illumination signal can provide constant power to the AMP STAs. If the AMP STAs are passive BKD devices, they can use the power in the illumination signal to perform the method 200. However, if the AMP STAs have energy storage components, then the method 200 can be performed without the AP transmitting the illumination signal. For example, the AMP STAs may have previously stored energy from other received RF signals which provides power for the AMP STA to perform the method 200.

At block 205, the AMP STA initiates a random timer. The AMP STA may initiate the timer after receiving the illumination signal from the AP or after receiving some other indication from the AP.

At block 210, the code selector in the AMP STA selects a code to use for transmission. In one embodiment, the code is selected randomly. In one example, the code selector may select the code based on the value of the random timer. Alternatively, the code selector may use a different random value to select the code so that the value of the random timer is independent of the code that is selected.

At block 215, the AMP STA determines whether there is a collision with the selected code. That is, at block 215, the AMP STA has not yet transmitted a wireless signal using the selected code. Instead, the AMP STA can listen to any other AMP STAS that may be transmitting to determine if they are using the same code as the AMP STA selected. Put differently, other AMP STAs may be also have started random timers at block 205 but may have already started transmitting due to their timers expiring first. Before transmitting, the AMP STAs can listen to other AMP STAs that have already started transmitting to determine whether those AMP STAs have selected the same code.

If the AMP STA detects another AMP STA using the same code, the method 200 proceeds to block 220 where the AMP STA chooses a different code. The AMP STA may choose the next code in the list of codes (e.g., increment a memory pointer to the next code stored in the code selector) or generate a new random value for selecting a new code.

Assuming a collision is not detected, the method 200 proceeds to block 225 where the AMP STA determines whether the random timer has expired. If not, the method 200 returns to block 215 to continue to listen to the transmissions of other AMP STAS whose timers have expired.

Once the timer expires and the AMP STA has a code which is not currently being used by other AMP STAs, the method 200 proceeds to block 230 where the AMP STA transmits using the selected code. That is, the AMP STA can use the selected code to transmit the reply 140 illustrated in FIG. 1.

In another embodiment, rather than first selecting a code at block 210 and then listening to see whether another AMP STA is using the code at block 215, the AMP STA can instead listen before the timer is expired and track the different codes being used. When the timer expires, the AMP STA can then select a code that it did not hear. That is, instead of first select a code and detect potential collisions, the AMP STA could track the codes it hears and then ensure it does not select one of those codes right before the AMP STA begins transmitting when its timer expires. For example, the AMP STA can select the code from a set of codes that does not include the codes used by any other AMP STAS.

In this manner, by instructing each AMP STA to use a random timer before transmitting, this permits the AMP STAs to begin transmitting at different times so that the AMP STAs can listen before transmitting to minimize the likelihood that two AMP STAs begin transmitting at the same time using the same code.

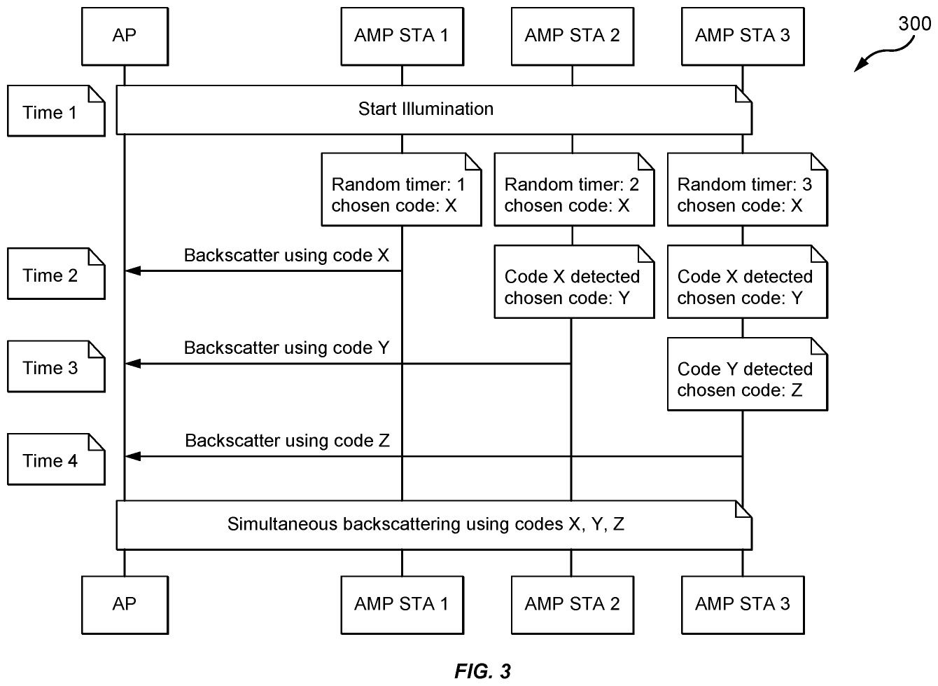

FIG. 3 is a timing chart 300 for selecting codes for AMP STAs, according to one embodiment. The timing chart 300 is one example of performing the blocks in the method 200 in FIG. 2.

The chart 300 illustrates at Time 1 that the AP transmits an illumination signal that is received by the AMP STAs 1, 2, and 3. This illumination signal may be transmitted continuously during the timing chart 300 to provide power to the AMP STAs (especially if they are passive BKD devices). Alternatively, the AP may transmit some other start signal in order to kick off the timing chart 300. This assumes the AMP STAs 1, 2, and 3 have their own energy storage components that have already been sufficiently charged.

In response to receiving the illumination signal, the AMP STAs 1, 2, and 3 start random timers and select one of a plurality of codes (e.g., orthogonal codes) stored in their memory. In this example, the AMP STA 1 has a random timer value of 1 and has selected Code X. The AMP STA 2 has a random timer value of 2 and has selected Code X. The AMP STA 3 has a random timer value of 3 and s has elected Code X. As such, if AMP STAs 1, 2, and 3 were to start transmitting at the same time using the same code (e.g., Code X), their signals would interfere and there would be a collision. Thus, FIG. 3 illustrates the worst case scenario where the three AMP STAs have selected the same orthogonal code.

Because AMP STA 1 has the random timer with the smallest value, it begins transmitting at Time 2 using Code X. As discussed in method 200, AMP STAs 2 and 3 are listening to the transmission of other AMP STAs while waiting for their timers to expire. As such, these STAs detect a collision (or a potential collision) since they have selected the same code as the code being used by AMP STA 1. In response, AMP STAs 2 and 3 select different codes either randomly or programmatically. In this case, AMP STA 2 and 3 both select Code Y. However, no collision is detected at this time since neither AMP STA 2 nor 3 is currently transmitting.

At Time 3, the random timer for AMP STA 2 expires and it begins transmitting using Code Y. AMP STA 3 is listening and thus detects that it has selected the same code as AMP STA 2. Accordingly, AMP STA 3 selects a different code either randomly or programmatically—e.g., Code Z.

At Time 4, the random timer for AMP STA 3 expires and it begins transmitting using Code Z. At this time, the AMP STAs 1, 2, and 3 can transmit simultaneously since they use different orthogonal codes.

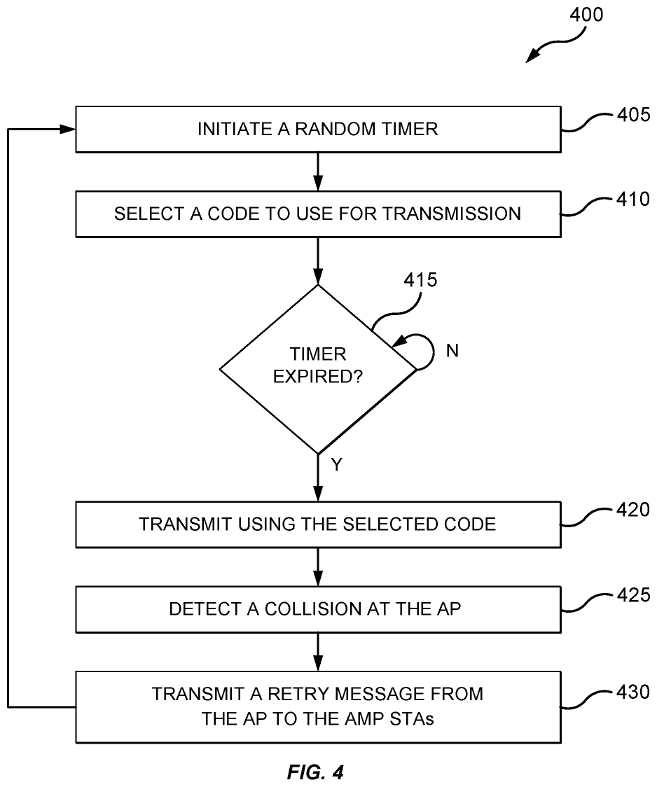

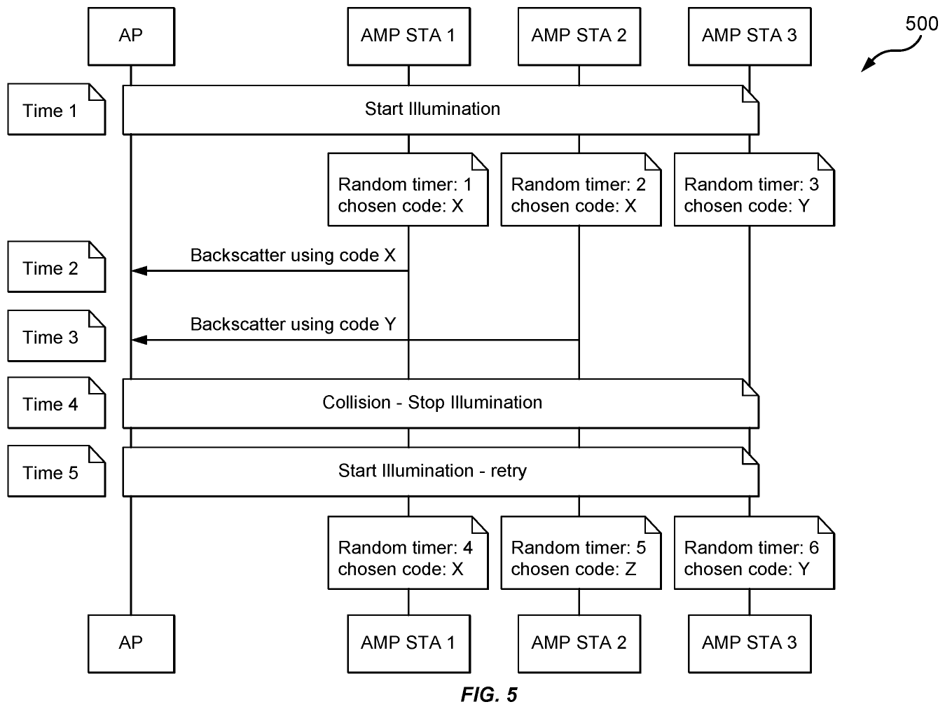

In some cases, the random timers and the selected codes for two AMP STAS may be the same. In that case, the two AMP STAs begin transmitting at the same time using the same code which creates a collision. This could be handled by the AP detecting the collision (which is discussed in FIGS. 4 and 5) or by the AMP STAs themselves detecting the collision. In any case, the two AMP STAs could reset their timers and select different codes, either in response to receiving an instruction from the AP or by their own volition after detecting a collision.

FIG. 4 is a flowchart of a method 400 for selecting codes for AMP STAS, according to one embodiment. Unlike in FIGS. 2 and 3 where a collision (or potential collision) is detected by the AMP STAs, in the method 400, collisions are detected by the AP. For example, the AMP STAs may not have logic or circuitry that is capable of listening to the transmissions from other AMP STAs and determining that they are using the same code it has selected.

At block 405, the AMP STA initiates a random timer. The AMP STA may initiate the timer after receiving the illumination signal from the AP or after receiving some other indication from the AP.

At block 410, the code selector in the AMP STA selects a code to use for transmission. In one embodiment, the code is selected randomly. In one example, the code selector may select the code based on the value of the random timer. Alternatively, the code selector may use a different random value to select the code so that the value of the random timer is independent of the code that is selected.

At block 415, the AMP STA determines whether its timer has expired. Once the timer has expired, the method 400 proceeds to block 420 where the AMP STA transmits using the code selected at block 410.

At block 420, the AP detects a collision where at least two AMP STAs are transmitting using the same code. That is, the method 400 assumes that two AMP STAS have selected the same code. The AP can detect, based on the signals received from the two AMP STAs, that they have selected the same code.

At block 425, the AP transmits a retry message to the AMP STAs which indicates a collision was detected. In response, the method 400 repeats where each AMP STA initiates the random timer at block 405 and selects a new code to use for transmission at block 410. The method 400 can repeat until each AMP STA within range of the AP has selected a different code.

FIG. 5 is a timing chart 500 for selecting codes for AMP STAs, according to one embodiment. The timing chart 500 is one example of performing the blocks in the method 400 in FIG. 4.

The chart 500 illustrates at Time 1 that the AP transmits an illumination signal that is received by the AMP STA 1, 2, and 3. This illumination signal may be transmitted continuously during the timing chart 500 to provide power to the AMP STAs (especially if they are passive BKD devices). Alternatively, the AP may transmit some other start signal in order to kick off the timing chart 500. This assumes the AMP STAs 1, 2, and 3 have their own energy storage components that have already been sufficiently charged.

In response to receiving the illumination signal, the AMP STAs 1, 2, and 3 start random timers and select one of a plurality of codes (e.g., orthogonal codes) stored in their memory. In this example, the AMP STA 1 has a random timer value of 1 and has selected Code X. The AMP STA 2 has a random timer value of 2 and has selected Code X. The AMP STA 3 has a random timer value of 3 and has selected Code Y.

At Time 2, the timer for AMP STA 1 expires and it begins transmitting using Code X. In this example, the AMP STA 2 does not listen to the transmission of AMP STA 1 (e.g., it may be incapable of doing so), and thus, does not detect that it has selected the same code as AMP STA 1.

At Time 3, the timer for AMP STA 2 expires and it begins transmitting using Code X. Now, both AMP STA 1 and 2 are transmitting in parallel using the same code—Code X.

At Time 4, the AP determines the collision and stops transmitting the illumination signal.

At Time 5, the AP transmits an illumination retry signal. This triggers (or instructs) the AMP STAs 1, 2, and 3 to repeat the process where they again select random timer values and random codes. In this example, the AMP STAs 1, 2, and 3 have selected different codes—i.e., Code X, Code Z, and Code Y. Thus, when their timer values expire there will be no collisions and the three AMP STAs can transmit simultaneously to the AP.

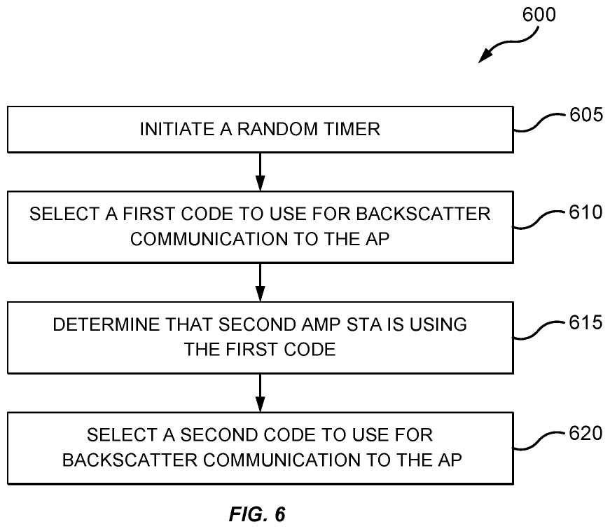

FIG. 6 is a flowchart of a method 600 for selecting codes for AMP STAS, according to one embodiment. At block 605, the AMP STA initiates a random timer. The AMP STA may initiate the timer after receiving the illumination signal from the AP or after receiving some other indication from the AP.

At block 610, the AMP STA selects a code to use for backscatter communication to the AP. In one embodiment, the code is selected randomly. In one example, the AMP STA may select the code based on the value of the random timer. Alternatively, the AMP STA may use a different random value to select the code so that the value of the random timer is independent of the code that is selected.

At block 615, the AMP STA determines that a second AMP STA is using the first code. In one example, as described in method 200 in FIG. 2, the AMP STA has logic or circuitry (e.g., the code selector 120 in FIG. 1) for detecting when another AMP STA is using the same code as it has selected. For example, the AMP STA may listen while waiting for its timer to expire to determine whether another AMP STA has selected the same code and has begun backscattered communications with the AP.

In another embodiment, the AMP STA does not have the capability to directly detect that another AMP STA has selected that code. In this example, the AMP STA determines that a second AMP STA has selected the same code via receiving a retry message from the AP as discussed in method 400 and the timing chart 500. That is, by receiving the retry from the AP, the AMP STA knows there was a collision and that it should select a different code. Thus, block 615 can include the AMP STA directly detecting a collision using its own logic or circuitry, or being informed of a collision indirectly by the AP.

At block 620, the AMP STA selects a second code to use for transmitting backscatter communications to the AP. For example, block 620 may occur before the AMP STA's timer has expired, as discussed in method 200 and timing chart 300. In that case, the AMP STA can select the second code while it is listening to other AMP STAS transmit to the AP before its timer has expired.

Alternatively, block 620 may occur after the AMP STA's timer has expired and it has begun backscatter communications using the first code, as discussed in method 400 and timing chart 500. In that case, the AMP STA selects the second code after receiving a retry message from the AP. Moreover, the AMP STA and the other AMP STAs in communication with the AP may select new values for respective random timers and new codes in response to receiving the retry message from the AP.

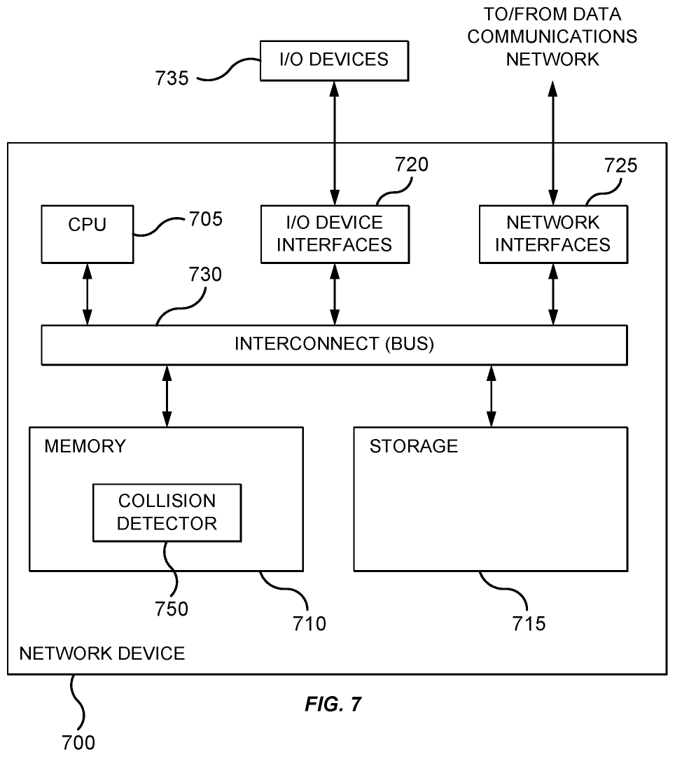

FIG. 7 depicts an example computing device (e.g., a network device 700) configured to perform various aspects of the present disclosure, according to some embodiments of the present disclosure. In some embodiments, the network device 700 corresponds to an AP 100 of FIG. 1. Although depicted as a physical device, in embodiments, the network device 700 may be implemented using virtual device(s), and/or across a number of devices (e.g., in a cloud environment).

As illustrated, the network device 700 includes a CPU 705, memory 710, storage 715, a network interface 725, and one or more I/O interfaces 720. In the illustrated embodiment, the CPU 705 (e.g., one or more processors) retrieves and executes programming instructions stored in memory 710, as well as stores and retrieves application data residing in storage 715. The CPU 705 is generally representative of a single CPU and/or GPU, multiple CPUs and/or GPUs, a single CPU and/or GPU having multiple processing cores, and the like. The memory 710 is generally included to be representative of a random access memory. Storage 715 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 735 (such as keyboards, monitors, etc.) are connected via the I/O interface(s) 720. Further, via the network interface 725, the network device 700 can be communicatively coupled with one or more other devices and components (e.g., via a network, which may include the Internet, local network(s), and the like). As illustrated, the CPU 705, memory 710, storage 715, network interface(s) 725, and I/O interface(s) 720 are communicatively coupled by one or more buses 730.

In the illustrated embodiment, the memory 710 includes a collision detector 750, which may perform one or more embodiments discussed above (e.g., block 425 of method 400). The collision detector 750 may detect when two AMP STAs are transmitting using the same code and instruct the AP to transmit a retry signal to the AMP STAs. Although depicted as discrete components for conceptual clarity, in embodiments, the operations of the depicted components (and others not illustrated) may be combined or distributed across any number of components. Further, although depicted as software residing in memory 710, in embodiments, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method comprising:
initiating, at a first ambient power station (AMP STA), a random timer upon receiving an illumination signal from an access point (AP);
selecting, at the first AMP STA and after receiving the illumination signal, a first code to use for backscatter communications transmitted to the AP; and
upon determining a second AMP STA is using the first code for backscatter communications, selecting, at the first AMP STA, a second code to use for backscatter communications to the AP.

2. The method of claim 1, wherein determining that the second AMP STA is using the first code comprises:
receiving at the first AMP STA a backscatter communication transmitted by the second AMP STA using the first code at a time before the random timer has expired, wherein the first AMP STA includes circuitry that determines that the second AMP STA is using the first code.

3. The method of claim 1, wherein determining that the second AMP STA is using the first code comprises:
receiving at the first AMP STA a retry message from the AP indicating a collision between the first AMP STA and the second AMP STA.

4. The method of claim 3, wherein the first AMP STA and the second AMP STA transmit wireless signal in parallel using the first code when the collision occurs, which is after the random timer has expired.

5. The method of claim 3, wherein the first AMP STA and the second AMP STA select different codes in response to receiving the retry message from the AP.

6. The method of claim 5, wherein both the first AMP STA and the second AMP STA select new values for respective random timers in response to receiving the retry message from the AP.

7. The method of claim 1, wherein the first AMP STA is a passive backscattering device that does not include a power storage element.

8. The method of claim 1, wherein the first AMP STA is a backscattering device that includes a power storage element that stores energy based on receiving the illumination signal from the AP.

9. The method of claim 1, wherein the first and second codes are orthogonal codes.

10. An AMP STA, comprising:
a random timer configured to initiate when the AMP STA receives an illumination signal from an AP; and
a code selector configured to select, after receiving the illumination signal, a first code to use for backscatter communications transmitted to the AP that is not used by any other AMP STA currently transmitting backscatter signals to the AP.

11. The AMP STA of claim 10, wherein the code selector is configured to:
select a second code before selecting the first code;
determine that a second AMP STA is using the second code by receiving at the AMP STA a backscatter communication transmitted by the second AMP STA using the second code at a time before the random timer has expired; and
select the first code.

12. The AMP STA of claim 10, wherein the code selector is configured to:
select a second code before selecting the first code, wherein the AMP STA is configured to transmit backscatter communications using the second code after the random timer has expired;
receive at the AMP STA a retry message from the AP indicating a collision between the AMP STA and a second AMP STA, wherein the AMP STA and the second AMP STA are configured to transmit wireless signal in parallel using the second code when the collision occurs, which is after the random timer has expired;
select the first code in response to receiving the retry message from the AP.

13. The AMP STA of claim 12, wherein the random timer is configured to select a new value in response to receiving the retry message from the AP.

14. The AMP STA of claim 10, wherein the code selector is configured to track codes used by other AMP STAs before the random timer expires and select the first code from a set of codes that does not include the codes used by the other AMP STAs.

15. The AMP STA of claim 10, wherein the AMP STA is one of (i) a passive backscattering device that does not include a power storage element or (ii) a backscattering device that includes a power storage element that stores energy based on receiving the illumination signal from the AP.

16. An AP, comprising:
one or more processors; and
memory configured to execute an application which, when executed by the one or more processors, performs an operation comprising:
transmitting an illumination signal to a first AMP STA and a second AMP STA, wherein the first AMP STA and the second AMP STA (i) initiate respective random timers and (ii) select orthogonal codes to use when transmitting backscatter communications to the AP,
detecting a collision when receiving backscatter communications from both the first AMP STA and the second AMP STA use a same orthogonal code, and
transmitting, in response to detecting the collision, a retry message to the first AMP STA and the second AMP STA, wherein the first AMP STA and a second AMP STA (i) reset the respective random timers and (ii) select new orthogonal codes to use when transmitting backscatter communications to the AP.

17. The AP of claim 16, wherein the first AMP STA and the second AMP STA transmit wireless signals in parallel using the same orthogonal code when the collision occurs, which is after the respective random timers have expired.

18. The AP of claim 16, wherein the first AMP STA and the second AMP STA select different codes in response to receiving the retry message from the AP.

19. The AP of claim 16, wherein both the first AMP STA and the second AMP STA select new values for the respective random timers in response to receiving the retry message from the AP.

20. The AP of claim 16, the first AMP STA and the second AMP STA do not have an ability to directly detect when another AMP STA is using the same orthogonal code.
